(19) United States
(12) Patent Application Publication
(10) Pub. No.: US 2019/0044286 A1
(43) Pub. Date: Feb. 7, 2019

(54) GROUND BAR AS A ROBUST GROUNDING SCHEME FOR A HIGH-SPEED CONNECTOR DESIGN

(71) Applicant: Intel Corporation, Santa Clara, CA (US)

(72) Inventors: Se-Jung MOON, Portland, OR (US); Hansel DSILVA, Hillsboro, OR (US); Beom-Taek LEE, Beaverton, OR (US)

(21) Appl. No.: 16/134,759

(22) Filed: Sep. 18, 2018

(51) Int. Cl. H01R 13/6471; H01R 13/652

(52) U.S. Cl. CPC H01R 13/6471; H01R 13/652

(57) ABSTRACT

In accordance with embodiments disclosed herein, there is provided a ground bar as a robust grounding scheme for a high-speed connector design. A connector includes a housing and a first signal pin, first and second ground pins, and a ground bar disposed within the housing. The housing includes a first receptacle through which a first circuit board is inserted. Responsive to the first circuit board being inserted into the first receptacle, the first signal pin is to contact a first contact electrode on the first circuit board, the first ground pin is to contact a first ground contact electrode on the first circuit board, and the second ground pin is to contact a second ground contact electrode on the first circuit board. The ground bar is connected between a first connection point of the first ground pin and a second connection point of the second ground pin.

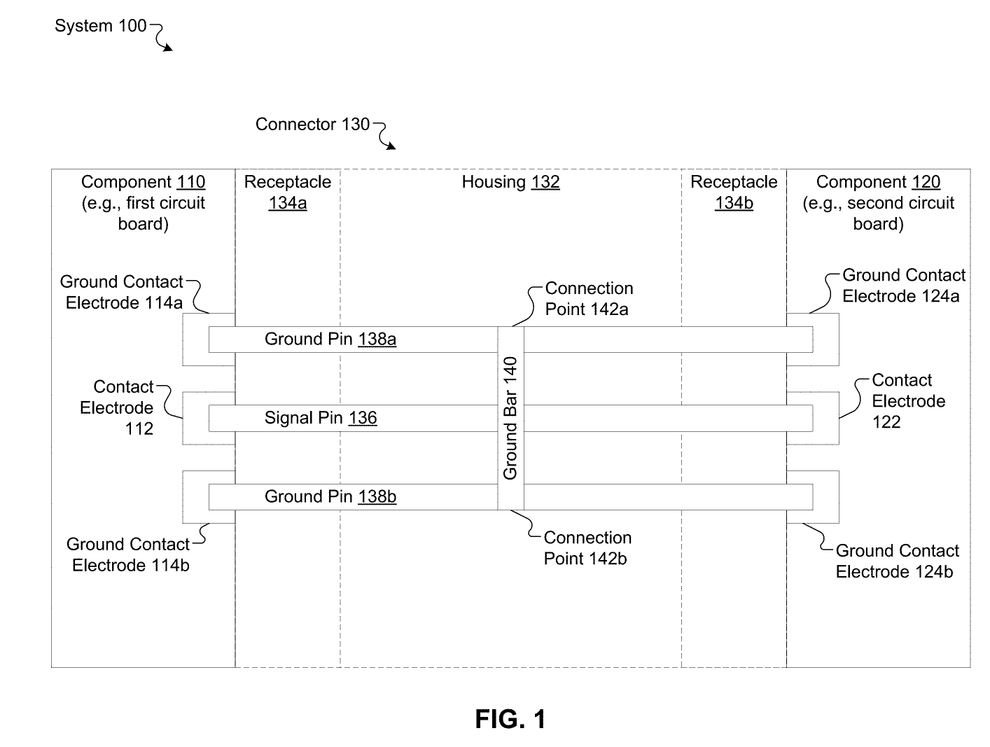

FIG. 1 illustrates a system including a first component and a second component coupled by a connector that includes a ground bar, according to certain embodiments.

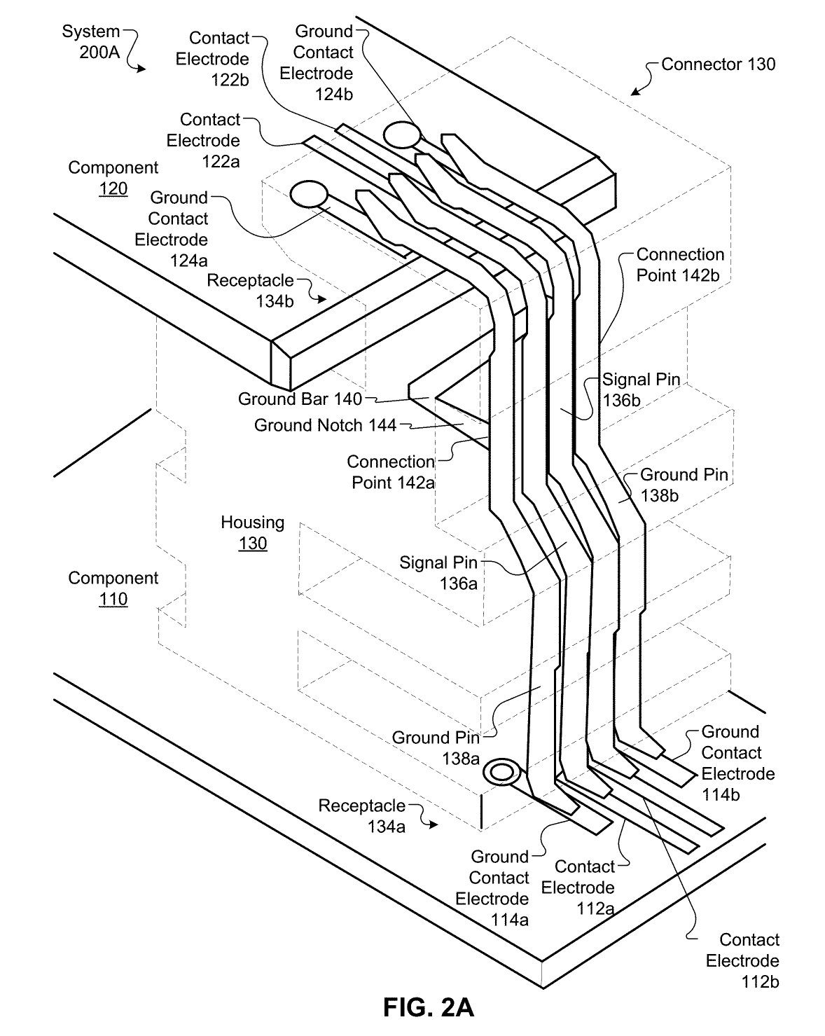

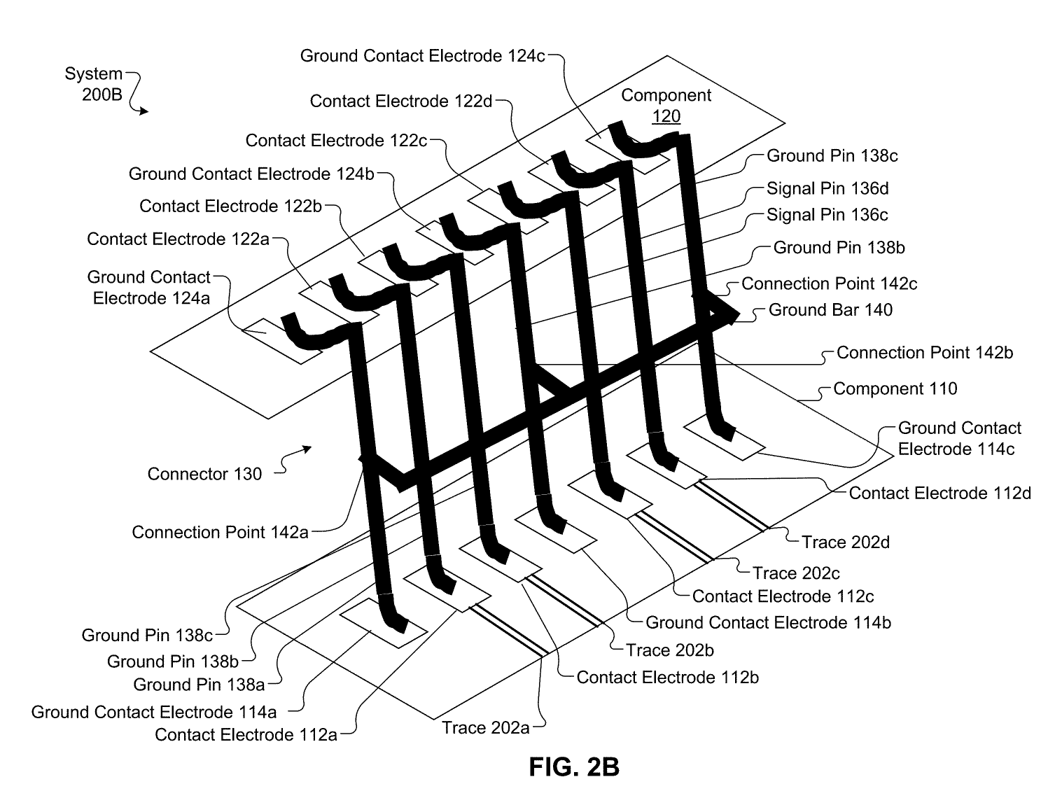

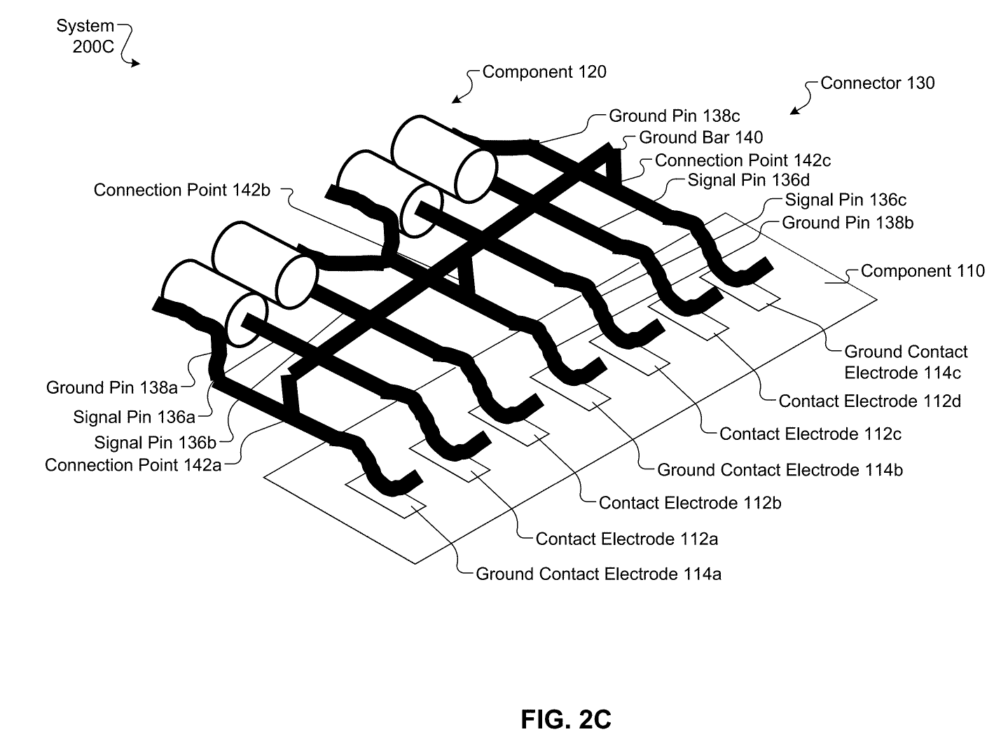

FIG. 2A illustrates a system including a first component and a second component coupled by a connector that includes a ground bar, according to certain embodiments.

FIG. 2B illustrates a system including a first component and a second component coupled by a connector that includes a ground bar, according to certain embodiments.

FIG. 2C illustrates a system including a first component and a second component coupled by a connector that includes a ground bar, according to certain embodiments.

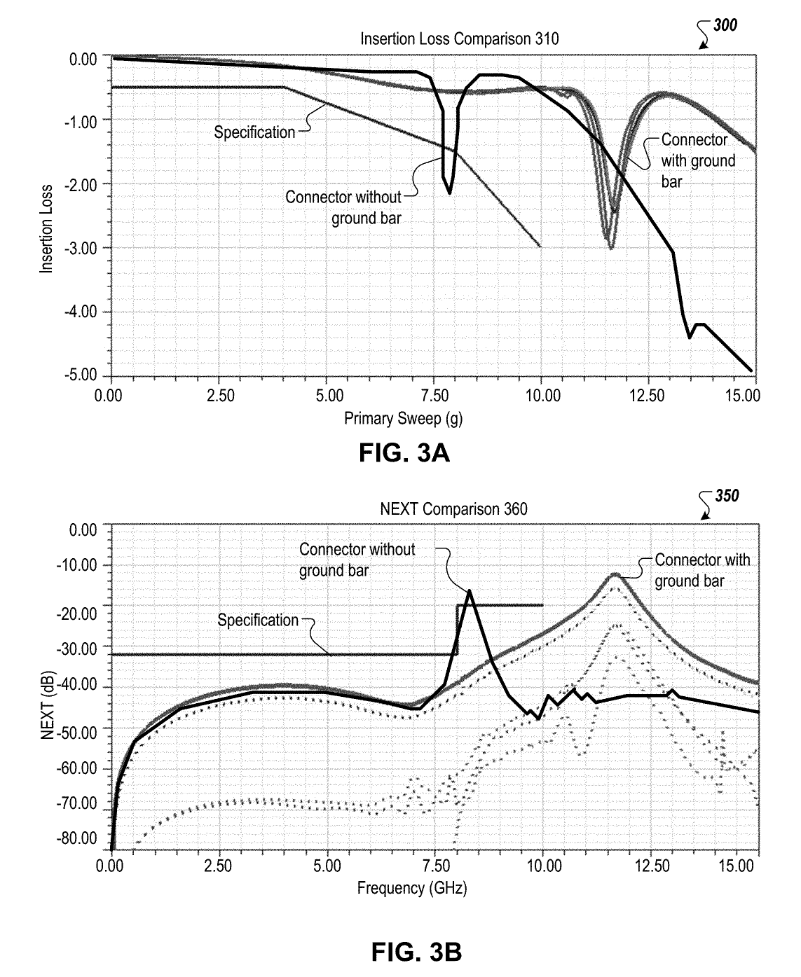

FIGS. 3A-B are graphs that illustrate a comparison between a connector with a ground bar and a connector without a ground bar, according to certain embodiments.

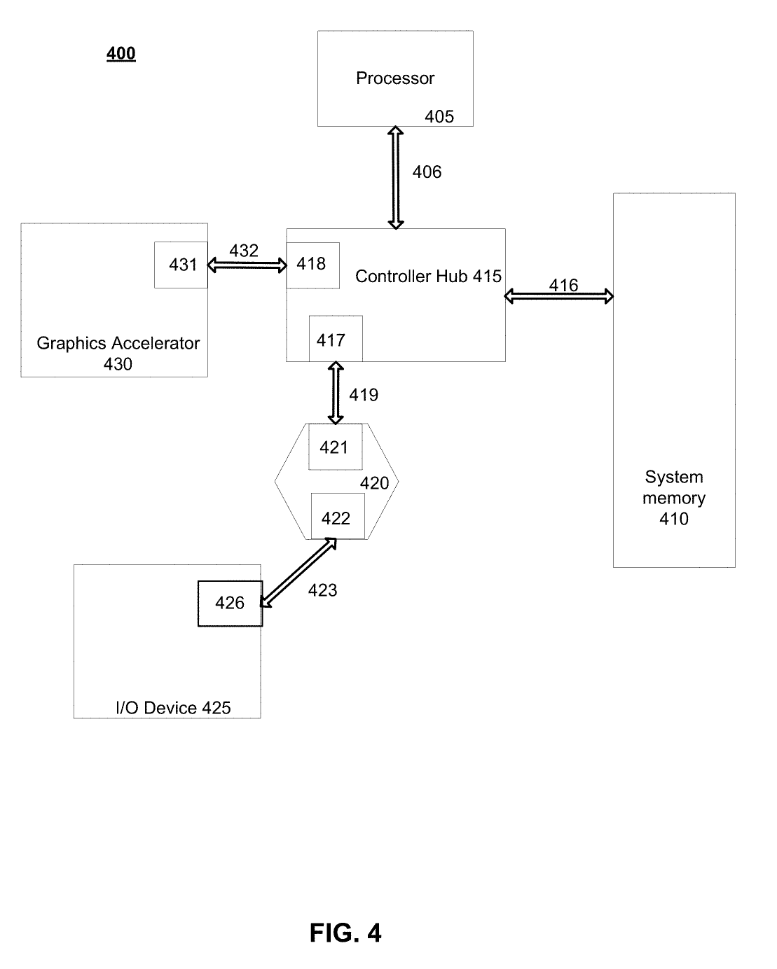

FIG. 4 illustrates a computer system with multiple interconnects, according to certain embodiments.

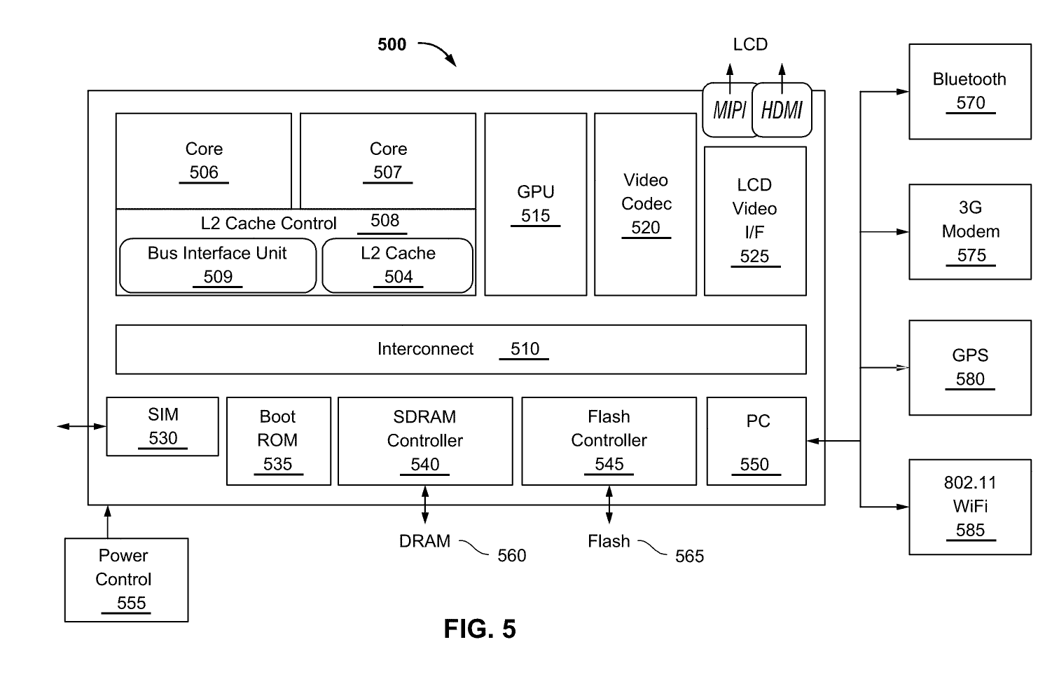

FIG. 5 illustrates a system on a chip (SOC) design, according to certain embodiments.

### DESCRIPTION OF EMBODIMENTS

Described herein are technologies directed to a ground bar as a robust grounding scheme (e.g., for a high-speed connector design, etc.). Connectors may be used to couple (e.g., electrically couple, communicatively couple, etc.) two components (e.g., printed circuit boards (PCBs), cable assembly, etc.). A connector may include a housing and pins disposed within the housing. The connector may be coupled to a first component and a second component so that signals may be sent from the first component to the second component via one or more of the pins disposed within the housing. The pins may include signal pins and ground pins. Resonance may occur on the ground pins which may cause an increase in insertion loss (IL) and crosstalk of the connector.

The ground pins provide imperfect signal return paths that cause resonance in the signaling. For example, the imperfect signal return path can introduce or increase insertion loss (IL) in the signaling. IL may be the loss of signal power. Resonance in the ground pins may introduce or increase signal loss in the pins. The imperfect signal return path may introduce or increase crosstalk in the signaling. Crosstalk may be a result of electric and magnetic fields between pins. When a signal is driven onto a pin, an electromagnetic wave is induced that carries the information from the driver to the receiver. When other signals are routed in the vicinity of driving signal, the electric and magnetic fields intersect the adjacent pins and induce crosstalk noise in the form of voltages and currents. The increased crosstalk noise degrades signal integrity and leads to functional problems on the pins that can reduce system performance (e.g., low or failing electrical margins leading to bit errors, broken communication lines, and other functional failures). Resonance in the ground pins may amplify the crosstalk in the pins.

As the data rate (e.g., frequency) of signals transmitted via connectors increases, resonance in the ground pins increases. The increase in resonance in the ground pins may cause the IL and/or crosstalk of a connector to violate specification requirements.

The devices, systems, and methods, as disclosed herein, provide a ground bar as a robust grounding scheme (e.g., for a high-speed connector design). A connector may include a housing including a first receptacle through which a first component is inserted. The first circuit board may include contact electrodes (e.g., signal pads) and ground contact electrodes (e.g., ground pads). A signal pin, a first ground pin, a second ground pin, and a ground bar may be disposed in the housing. Responsive to the first component being inserted into the first receptacle, the signal pin may contact a contact electrode on the first component, the first ground pin may contact a first ground contact electrode on the first component, and a second ground pin may contact a second ground contact electrode on the first component. The ground bar may be connected between a first connection point of the first ground pin and a second connection point of the second ground pin.

The ground bar may provide a common solid return path for signal pins to mitigate resonance on the ground pins and to lessen the IL and/or crosstalk of the connector. The ground bar may decrease loss of signal power in the pins. The ground bar may decrease the crosstalk in the signaling. The ground bar may allow connectors of increased lengths and/or increased data rate to meet specification requirements.

FIG. 1 illustrates a system 100 including a first component 110 and a second component 120 coupled by a connector 130 (e.g., interconnect assembly) that includes a ground bar 140, according to certain embodiments.

The components 110 and 120 may be a printed circuit boards (PCBs), flexible attachment, cable assembly, add-in card (AIC), etc. In some embodiments, both component 110 and component 120 are the same type of component (e.g., both are PCBs, both are flexible attachments, both are cable assemblies, etc.). In some embodiments, component 110 and component 120 are different types of components (e.g., PCB and flexible attachment, PCB and cable assembly, PCB and AIC, etc.). Component 110 may include contact electrodes 112 (e.g., signal pads) and ground contact electrodes 114 (e.g., ground pads) disposed on a surface of the component 110. Component 120 may include contact electrodes 122 (e.g., signal pads) and ground contact electrodes 124 (e.g., ground pads) disposed on a surface of the component 120.

In some embodiments, components 110 and 120 are in the same plane. In some embodiments, component 110 is in a first plane and component 120 is in a second plane that is substantially parallel to the first plane (see FIG. 2A). In some embodiments, component 110 is in a first plane and component 120 is in a second plane that is substantially perpendicular to the first plane. In some embodiments, component 110 is in a first plane and component 120 is in a second plane that is neither parallel nor perpendicular to the first plane.

The connector 130 may include a housing 132. In some embodiments, the housing 132 may include a receptacle 134a to couple to (e.g., to receive) component 110. In some embodiments, the housing 132 may include a receptacle 134b to couple to (e.g., to receive) component 120. For example, connector 130 may be an edge connector that has a receptacle to receive a PCB or an add-in card (AIC) (e.g., component 120). In another example, connector 130 may be a cable assembly connector (e.g., a cable assembly mated to a PCB or package). The connector 130 may be one or more of a male connector or a female connector.

One or more signal pins 136 and two or more ground pins 138 may be disposed in the housing 132. Responsive to housing 132 contacting component 110 (e.g., responsive to component 110 being inserted into receptacle 134a), ground contact electrode 114a may contact a first end of ground pin 138a, contact electrode 112 may contact a first end of signal pin 136, and ground contact electrode 114b may contact a first end of ground pin 138b. Responsive to housing 132 contacting component 120 (e.g., responsive to component 120 being inserted into receptacle 134b), ground contact electrode 124a may contact a second end of ground pin 138a, contact electrode 122 may contact a second end of signal pin 136, and ground contact electrode 124b may contact a second end of ground pin 138b.

In some embodiments, there may be an equal ratio of signal pins 136 and ground pins 138. In some embodiments, the signal pins 136 (S) and ground pins 138 (G) may be in a GSSG order.

The ground pins 138 and the signal pins 136 may be routed in the same direction (e.g., routed horizontally, routed vertically, etc.). In some embodiments, the ground pins 138 and the signal pins 136 may be substantially parallel to each other. In some embodiments, the ground pins 138 and the signal pins 136 may have the dimensions and orientation. In some embodiments, the signal pins 136 may be shaped to not contact the ground bar 140 (e.g., to prevent a short circuit).

A ground bar 140 may be connected to the ground pins 138 at corresponding connection points 142 (e.g., connected to ground pin 138a at a connection point 142a and to ground pin 138b at connection point 142b). In some embodiments, the ground bar 140 may bind ground pins 138 substantially in the middle of the connector 130 (e.g., at a middle portion of the ground pins 138). The ground bar 140 is conductive to electrically connect the ground pins 138 within the connector 130. In some embodiments, the ground bar 140 is made of the same material as the ground pins 138. In some embodiments, the ground bar 140 is made of a first material and the ground pins 138 are made of a second material (e.g., first material and second material are electrically conductive). In some embodiments, the ground bar 140 has a similar thickness as a ground pin 138. In some embodiments, the ground bar 140 has a different thickness (e.g., smaller thickness) than a ground pin 138.

In some embodiments, the housing 132 may include a single ground bar 140 and the connection points 142 are at a middle portion of the ground pins 138. The ground bar 140 may connect to each of the ground pins 138 in the housing 132 without contacting any signal pins 136 in the housing. The ground bar 140 may connect to each of the ground pins 138 in the housing 132 without contacting an additional ground component. The ground bar 140 may contact only the ground pins 138 (e.g., without contacting any other components). Addition of ground bar 140 to the connector 130 may resolve resonance in the ground pins 138. The ground bar 140 constructs a common ground structure within the connector 130. Use of a ground bar 140 in connector 130 may enable the connector 130 to be used for high speed (e.g., above one Gigahertz (GHz) input/output (I/O) (e.g., which conventionally is impeded by ground resonance).

Resonance in the ground pins 138 may be caused by one or more of the length of ground pins 138 or the data speed of signals transmitted via the connector 130. For example, IL and/or crosstalk that violate the specification may be caused by resonance in the ground pins 138 in a connector 130 responsive to the connector 130 carrying signals of one or more Gigahertz (GHz) (e.g., at least 1 GHz, at least 8 GHz, etc.). In another example, IL and/or crosstalk that violate the specification may be caused by a threshold resonance in ground pins 138 in a connector 130 responsive to the ground pins 138 meeting a threshold length (e.g., 5-6 millimeters (mm)).

Resonance in the ground pins 138 may generated based on data speed, length of the ground pins 138, and ground bars 140 (e.g., number and location of ground bars) (e.g., there is a relationship between resonance in the ground pins 138 and the data speed, length of ground pins 138, and ground bars 140). An increased data speed may increase the resonance in the ground pins 138. An increased length of ground pins 138 (e.g., where length of connector pins are electrically substantial and create resonance near signaling rate (e.g., Nyquist frequency)) may increase the resonance in the ground pins 138. An increased number of uniformly spaced ground bars 140 may decrease the resonance in the ground pins 138. For example, a ground pin 138 that is 5-6 mm in length in a connector 130 that transmits signals of 8 GHz may require one ground bar 140 to reduce the resonance of the ground pins 138 so that the insertion loss and crosstalk do not violate the specification.

The connector 130 with a ground bar 140 may be used to transmit signals via one or more protocols such as peripheral component interconnect Express® (PCIe®), Ethernet, Omni-Path Interconnect, UltraPath Interconnect, etc.

Design of the ground bar 140 may be further refined and adjusted based on design of the connector 130, electrical specification, manufacturing processes, etc.

Different implementation methods of the ground bar 140 may be used. In one embodiment, conductive material may be inserted in a mold to form the ground bar 140 and only the ground pins 138 may be allowed to contact the ground bar 140 in the mold (e.g., when the ground pins 138 are inserted in the mold). The location, size, and shape of the ground bar 140 may vary for effective and efficient implementation depending on connector structure.

The ground bar 140 may be maintained a threshold distance away from the signal pins 136 (e.g., to avoid impedance variation in the connector 130 (e.g., in the signal pins 136)). For example, the ground bar 140 may include a ground notch 144a connected to ground pin 138a and a ground notch 144b connected to ground pin 138b, where the ground notch 144a and the ground notch 144b maintain the ground bar at least a threshold distance away from the signal pins 136. In some embodiments (e.g., for each of the signal pins 136), the threshold distance between the ground bar 140 and a signal pin 136 is greater than the distance between the signal pin 136 and the nearest ground pin 138. In some embodiments (e.g., for each of the signal pins 136), the threshold distance between the ground bar 140 and a signal pin 136 is the same or greater than the distance between the signal pin 136 and the nearest ground pin 138.

Responsive to one ground bar 140 not being enough to push the ground resonance to a higher frequency region (e.g., see FIGS. 3A-B), one or more additional ground bars 140 may be used. The ground bars 140 may be substantially evenly spaced out along the length of the ground pins 138 (e.g., substantially uniformly distributed). For example, for two ground bars 140, a first ground bar 140a may be disposed substantially one third of the distance from a first end to a second end of the ground pins 138 and a second ground bar 140b may be disposed substantially two thirds of the distance from the first end to the second end of the ground pins 138.

FIG. 2A illustrates a system 200A including a first component 110 and a second component 120 coupled by a connector 130 that includes a ground bar 140, according to certain embodiments. Features with similar reference numbers as those in FIG. 1 may have similar functionalities as the corresponding features in FIG. 1.

In some embodiments, the connector 130 is an edge connector, the first component 110 is a first PCB, and the second component 120 is a second PCB (e.g., an add-in card). A first distal end of the pins 136 and 138 (e.g., proximate receptacle 134a) may be soldered to the contact electrodes 112 and 114 of the component 110 (e.g., to permanently contact the component 110). A second distal end of the pins 136 and 138 (e.g., proximate receptacle 134b) may be a spring contact (e.g., to removably contact component 120 at the contact electrodes 122 and 124).

FIG. 2B illustrates a system 200B including a first component 110 and a second component 120 coupled by a connector 130 that includes a ground bar 140, according to certain embodiments. Features with similar reference numbers as those in FIG. 1 may have similar functionalities as the corresponding features in FIG. 1.

The connector 130 may be an edge card connector. In some embodiments, component 110 is a first PCB (e.g., a base board), the contact electrodes 112 and ground contact electrodes 114 are solder pads, component 120 is a second PCB (e.g., an add-in card (AIC)), and the contact electrodes 122 and ground contact electrodes 124 are gold finger pads for contact. Each of the contact electrodes 112 on the component 110 may be coupled to a corresponding trace 202 of the component 110. The connector 130 (e.g., edge card connector) may be soldered on top of component 110 (e.g., soldered to the solder pads of the base board) and the connector pins (e.g., signal pins 136 and ground pins 138) may contact the contact electrodes 122 and ground contact electrodes 124 of the component 120 (e.g., contact the gold finger pads on the AIC).

FIG. 2C illustrates a system 200C including a first component 110 and a second component 120 coupled by a connector 130 that includes a ground bar 140, according to certain embodiments. Features with similar reference numbers as those in FIG. 1 may have similar functionalities as the corresponding features in FIG. 1. In some embodiments, component 110 is a first PCB, the contact electrodes 112 and ground contact electrodes 114 are gold finger pads for contact, and component 120 is a cable assembly.

FIGS. 3A-B are graphs that illustrate a comparison between a connector without a ground bar and a connector 130 with a ground bar 140, according to certain embodiments. As illustrated in FIGS. 3A-B, a connector 130 with a ground bar 140 increases the resonance frequency of the connector 130 (e.g., by mitigating or resolving the ground resonance and pushing the performance of the connector 130 to a higher frequency). The connector 130 with a ground bar 140 pushes the ground resonance out of the specification region and resolves the specification violation. For example, in FIGS. 3A-B, addition of a ground bar moves the resonance frequency from 8 GHz to 11.5 GHz to control the resonance of the ground pins 138 (e.g., control the ground resonance) and improve the connector performance.

FIG. 3A is a graph 300 that illustrates an insertion loss comparison 310 of a connector without a ground bar and a connector 130 with a ground bar 140, according to certain embodiments. Graph 300 displays specification for insertion loss (e.g., PCIe® connector IL limit in PCIe® card electromechanical (CEM) specification). As illustrated in graph 300, a connector without a ground bar may have a resonance frequency around 8 GHz and a connector 130 with a ground bar 140 may have a resonance frequency around 11.5 GHz. The resonance frequency of the connector without a ground bar causes the insertion loss of the connector to not be within specification at 8 GHz (e.g., induces a specification violation). The ground bar 140 causes the resonance frequency of the connector 130 to be moved from 8 GHz to 11.5 GHz which causes the insertion loss of connector 130 to be within specification.

FIG. 3B is a graph 350 that illustrates a near-end crosstalk (NEXT) (e.g., power sum of NEXT) comparison 360 of a connector without a ground bar and a connector 130 with a ground bar 140, according to certain embodiments. Graph 350 displays specification for NEXT (e.g., PCIe® connector NEXT limit in PCIe® card electromechanical (CEM) specification). As illustrated in graph 350, a connector without a ground bar may have a resonance frequency around 8 GHz and a connector 130 with a ground bar 140 may have a resonance frequency around 11.5 GHz. The resonance frequency of the connector without a ground bar causes the NEXT of the connector to not be within specification at 8 GHz (e.g., induces a specification violation). The ground bar 140 causes the resonance frequency of the connector 130 to be moved from 8 GHz to 11.5 GHz which causes the NEXT of connector 130 to be within specification.

FIG. 4 illustrates a computer system 400 with multiple interconnects, according to certain embodiments. System 400 includes processor 405 and system memory 410 coupled to controller hub 415. Processor 405 includes any processing element, such as a microprocessor, a host processor, an embedded processor, a co-processor, or other processor. Processor 405 is coupled to controller hub 415 through front-side bus (FSB) 406. In one embodiment, FSB 406 is a serial point-to-point interconnect as described below. In another embodiment, FSB 406 (e.g., link) includes a serial, differential interconnect architecture that is compliant with different interconnect standards.

System memory 410 includes any memory device, such as random access memory (RAM), non-volatile (NV) memory, or other memory accessible by devices in system 400. System memory 410 is coupled to controller hub 415 through memory interface 416. Examples of a memory interface include a double-data rate (DDR) memory interface, a dual-channel DDR memory interface, and a dynamic RAM (DRAM) memory interface.

In one embodiment, controller hub 415 is a root hub, root complex, or root controller. Examples of controller hub 415 include a chipset, a memory controller hub (MCH), a north bridge, an interconnect controller hub (ICH) a south bridge, and a root controller/hub. Often the term chipset refers to two physically separate controller hubs, i.e. a memory controller hub (MCH) coupled to an interconnect controller hub (ICH). Note that current systems often include the MCH integrated with processor 405, while controller 415 is to communicate with I/O devices, in a similar manner as described below. In some embodiments, peer-to-peer routing is optionally supported through root complex (e.g., controller 415).

Here, controller hub 415 is coupled to switch/bridge 420 through serial link 419. Input/output modules 417 and 421, which may also be referred to as interfaces/ports 417 and 421, include/implement a layered protocol stack to provide communication between controller hub 415 and switch 420. In one embodiment, multiple devices are capable of being coupled to switch 420.

Switch/bridge 420 routes packets/messages from device 425 upstream, i.e. up a hierarchy towards a root complex, to controller hub 415 and downstream, i.e. down a hierarchy away from a root controller, from processor 405 or system memory 410 to device 425. Switch 420, in one embodiment, is referred to as a logical assembly of multiple virtual PCI-to-PCI bridge devices. Device 425 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Fire wire device, a Universal Serial Bus (USB) device, a scanner, and other input/output devices. Often in the PCIe® vernacular, such as device, is referred to as an endpoint. Although not specifically shown, device 425 may include a PCIe® to PCI/PCI-X bridge to support legacy or other version PCI devices. Endpoint devices in PCIe® are often classified as legacy, PCIe®, or root complex integrated endpoints.

Graphics accelerator 430 is also coupled to controller hub 415 through serial link 432. In one embodiment, graphics accelerator 430 is coupled to an MCH, which is coupled to an ICH. Switch 420, and accordingly I/O device 425, is then coupled to the ICH. I/O modules 431 and 418 are also to implement a layered protocol stack to communicate between graphics accelerator 430 and controller hub 415. Similar to the MCH discussion above, a graphics controller or the graphics accelerator 430 itself may be integrated in processor 405.

I/O device 425 includes an interface 426 and switch/bridge 420 includes an interface 422. Interface 426 is coupled to interface 422 via serial link 423.

In one embodiment, short range wireless engines including a WLAN unit and a Bluetooth® unit may couple to processor 405 via an interconnect according to a PCIe® protocol, e.g., in accordance with the PCI Express® Specification Base Specification version 3.0 (published Jan. 17, 2004), or another such protocol such as a serial data input/output (SDIO) standard. Of course, the actual physical connection between these peripheral devices, which may be configured on one or more add-in cards, can be by way of the NGFF connectors adapted to a motherboard. Using WLAN unit, Wi-Fi® communications in accordance with a given Institute of Electrical and Electronics Engineers (IEEE) 802.11 standard can be realized, while via a unit using the Bluetooth® technology, short range communications via a Bluetooth® protocol can occur. In another embodiment, these units may communicate with processor 405 via, e.g., a USB link or a universal asynchronous receiver transmitter (UART) link.

One or more of the components of system 400 may be coupled by a connector 130 that has a ground bar 140 as described within. For example, one or more of FSB 406, memory interface 416, serial link 419, serial link 423, or serial link 432 may be over one or more connectors 130 that has a ground bar 140.

Turning next to FIG. 5, an embodiment of a system on-chip (SOC) design in accordance with the disclosures is depicted. As a specific illustrative example, SOC 500 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 500 includes 2 cores—506 and 507. Similar to the discussion above, cores 506 and 507 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 506 and 507 are coupled to cache control 508 that is associated with bus interface unit 509 and L2 cache 504 to communicate with other parts of system 500. Interconnect 510 includes an on-chip interconnect, such as an IOSF, AMBA, or other interconnect discussed above, which potentially implements one or more aspects of the described disclosure.

Interconnect 510 (e.g., interface) provides communication channels to the other components, such as a Subscriber Identity Module (SIM) 530 to interface with a SIM card, a boot rom 535 to hold boot code for execution by cores 506 and 507 to initialize and boot SOC 500, a SDRAM controller 540 to interface with external memory (e.g. DRAM 560), a flash controller 545 to interface with non-volatile memory (e.g. Flash 565), a peripheral control 550 (e.g. Serial Peripheral Interface) to interface with peripherals, video codecs 520 and Video interface 525 to display and receive input (e.g. touch enabled input), GPU 515 to perform graphics related computations, etc. Any of these interfaces may incorporate aspects of the disclosure described herein.

In some embodiments, interconnect 510 may include one or more connectors 130 with a ground bar 140 as described herein. Interconnect 510 may include connectors 130 with a ground bar to couple one or more components of SOC 500.

In addition, the system illustrates peripherals for communication, such as a Bluetooth® module 570, 3G modem 575, GPS 585, and Wi-Fi® 585. Note as stated above, a UE includes a radio for communication. As a result, these peripheral communication modules are not all required. However, in a UE some form a radio for external communication is to be included. The SOC 500 may be coupled to the peripherals via a connector 130 with a ground bar 140 as described herein.

The following examples pertain to further embodiments.

Example 1 is a connector comprising: a housing comprising a first receptacle through which a first circuit board is inserted; a first signal pin disposed within the housing, the first signal pin to contact a first contact electrode on the first circuit board responsive to the first circuit board being inserted into the first receptacle; a first ground pin disposed within the housing, the first ground pin to contact a first ground contact electrode on the first circuit board responsive to the first circuit board being inserted into the first receptacle; a second ground pin disposed within the housing, the second ground pin to contact a second ground contact electrode on the first circuit board responsive to the first circuit board being inserted into the first receptacle; and a ground bar disposed within the housing, the ground bar connected between a first connection point of the first ground pin and a second connection point of the second ground pin.

In Example 2, the subject matter of Example 1, wherein the connector comprises a plurality of ground pins disposed within the housing; the plurality of ground pins comprises the first ground pin and the second ground pin; and the ground bar is connected to each of the plurality of ground pins at a corresponding middle portion of each of the plurality of ground pins without contacting an additional ground component.

In Example 3, the subject matter of any one of Examples 1-2, wherein a corresponding first distal end of each of the first signal pin, the first ground pin, and the second ground pin is to contact the first circuit board and a corresponding second distal end of each of the first signal pin, the first ground pin, and the second ground pin is to contact a corresponding contact electrode of a second circuit board.

In Example 4, the subject matter of any one of Examples 1-3, wherein the connector comprises a plurality of signal pins disposed within the housing; the plurality of signal pins comprises the first signal pin; and for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.

In Example 5, the subject matter of any one of Examples 1-4, wherein the ground bar comprises a first ground notch connected to the first ground pin and a second ground notch connected to the second ground pin, wherein the first ground notch and the second ground notch maintain the ground bar at least a threshold distance away from the first signal pin.

In Example 6, the subject matter of any one of Examples 1-5, wherein the first signal pin, the first ground pin, and the second ground pin are substantially parallel to each other and are substantially perpendicular to the ground bar.

In Example 7, the subject matter of any one of Examples 1-6, wherein the ground bar is connected to the first ground pin and the second ground pin without contacting the first signal pin, wherein the ground bar conductively couples the first ground pin and the second ground pin.

In Example 8, the subject matter of any one of Examples 1-7 further comprising an additional ground bar disposed within the housing, wherein the ground bar and the additional ground bar are uniformly distributed in connecting the first ground pin and the second ground pin at corresponding middle portions of the first ground pin and the second ground pin.

Example 9 is a system comprising: a first component; a second component; and a connector comprising: a housing comprising a first receptacle through which the first component is inserted; a first signal pin disposed within the housing, the first signal pin to contact a first contact electrode on the first component responsive to the first component being inserted into the first receptacle; a first ground pin disposed within the housing, the first ground pin to contact a first ground contact electrode on the first component responsive to the first component being inserted into the first receptacle; a second ground pin disposed within the housing, the second ground pin to contact a second ground contact electrode on the first component responsive to the first component being inserted into the first receptacle; and a ground bar disposed within the housing, the ground bar connected between a first connection point of the first ground pin and a second connection point of the second ground pin.

In Example 10, the subject matter of Example 9, wherein the connector comprises a plurality of ground pins disposed within the housing; the plurality of ground pins comprises the first ground pin and the second ground pin; and the ground bar is connected to each of the plurality of ground pins at a corresponding middle portion of each of the plurality of ground pins without contacting an additional ground component.

In Example 11, the subject matter of any one of Examples 9-10, wherein a corresponding first distal end of each of the first signal pin, the first ground pin, and the second ground pin is to contact the first component and a corresponding second distal end of each of the first signal pin, the first ground pin, and the second ground pin is to contact a corresponding contact electrode of the second component.

In Example 12, the subject matter of any one of Examples 9-11, wherein the connector comprises a plurality of signal pins disposed within the housing; the plurality of signal pins comprises the first signal pin; and for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.

In Example 13, the subject matter of any one of Examples 9-12, wherein the ground bar comprises a first ground notch connected to the first ground pin and a second ground notch connected to the second ground pin; the first ground notch and the second ground notch maintain the ground bar at least a threshold distance away from the first signal pin; and the first signal pin, the first ground pin, and the second ground pin are substantially parallel to each other and are substantially perpendicular to the ground bar.

In Example 14, the subject matter of any one of Examples 9-13, wherein the first component is an edge card connector and the second component is an add-in card (AIC).

In Example 15, the subject matter of any one of Examples 9-14, wherein the first component is a printed circuit board (PCB) and the second component is a cable assembly.

Example 16 is an interconnect assembly comprising: a housing comprising a first distal end to couple to a first component and a second distal end to couple to a second component; a first signal pin disposed within the housing, the first signal pin to contact a first contact electrode on the first component at the first distal end to contact a second contact electrode on the second component at the second distal end; a first ground pin disposed within the housing, the first ground pin to contact a first ground contact electrode on the first component at the first distal end and to contact a second ground contact electrode on the second component at the second distal end; a second ground pin disposed within the housing, the second ground pin to contact a third ground contact electrode on the first component at the first distal end and to contact a fourth ground contact electrode on the second component at the second distal end; and a ground bar disposed within the housing, the ground bar connected between a first connection point of the first ground pin and a second connection point of the second ground pin.

In Example 17, the subject matter of Example 16, wherein the interconnect assembly is an edge card connector and the first component is an add-in card.

In Example 18, the subject matter of any one of Examples 16-17, wherein the interconnect assembly is a cable assembly connector and the first component is a cable assembly.

In Example 19, the subject matter of any one of Examples 16-18, wherein: the interconnect assembly comprises a plurality of ground pins disposed within the housing; the plurality of ground pins comprises the first ground pin and the second ground pin; and the ground bar is connected to each of the plurality of ground pins at a corresponding middle portion of each of the plurality of ground pins without contacting an additional ground component.

In Example 20, the subject matter of any one of Examples 16-19, wherein the interconnect assembly comprises a plurality of signal pins disposed within the housing; the plurality of signal pins comprises the first signal pin; and for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.

Various embodiments can have different combinations of the structural features described above. For instance, all optional features of the computing system described above can also be implemented with respect to the method or process described herein and specifics in the examples can be used anywhere in one or more embodiments.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler embodiments, specific expression of algorithms in code, specific power down and gating techniques/logic and other specific operational details of computer system have not been described in detail in order to avoid unnecessarily obscuring the present disclosure.

The embodiments may be described with reference to components in high speed I/O (HSIO) devices in specific integrated circuits, such as in computing platforms or microprocessors. The embodiments can also be applicable to other types of integrated circuits and programmable logic devices. For example, the disclosed embodiments are not limited to desktop computer systems or portable computers, such as the Intel® Ultrabooks™ computers, and can be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments can especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but can also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible embodiments of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) can refer to the combination of the microcontroller and the non-transitory medium. Often module boundaries that are illustrated as separate commonly vary and potentially overlap. For example, a first and a second module can share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate can provide a 0 or a 1 during operation. But a logic gate ‘configured to’ provide an enable signal to a clock does not include every potential logic gate that can provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but can refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “contacting,” “coupling,” “conducting,” “transmitting,” “receiving,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and can not necessarily have an ordinal meaning according to their numerical designation.

What is claimed is:

1. A connector comprising:
a housing comprising a first receptacle through which a first circuit board is inserted;
a first signal pin disposed within the housing, the first signal pin to contact a first contact electrode on the first circuit board responsive to the first circuit board being inserted into the first receptacle;
a first ground pin disposed within the housing, the first ground pin to contact a first ground contact electrode on the first circuit board responsive to the first circuit board being inserted into the first receptacle;
a second ground pin disposed within the housing, the second ground pin to contact a second ground contact electrode on the first circuit board responsive to the first circuit board being inserted into the first receptacle; and
a ground bar disposed within the housing, the ground bar connected between a first connection point of the first ground pin and a second connection point of the second ground pin.

2. The connector of claim 1, wherein:
the connector comprises a plurality of ground pins disposed within the housing;
the plurality of ground pins comprises the first ground pin and the second ground pin; and
the ground bar is connected to each of the plurality of ground pins at a corresponding middle portion of each of the plurality of ground pins without contacting an additional ground component.

3. The connector of claim 1, wherein a corresponding first distal end of each of the first signal pin, the first ground pin, and the second ground pin is to contact the first circuit board and a corresponding second distal end of each of the first signal pin, the first ground pin, and the second ground pin is to contact a corresponding contact electrode of a second circuit board.

4. The connector of claim 1, wherein:
the connector comprises a plurality of signal pins disposed within the housing;
the plurality of signal pins comprises the first signal pin; and
for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.

5. The connector of claim 1, wherein the ground bar comprises a first ground notch connected to the first ground pin and a second ground notch connected to the second ground pin, wherein the first ground notch and the second ground notch maintain the ground bar at least a threshold distance away from the first signal pin.

6. The connector of claim 1, wherein the first signal pin, the first ground pin, and the second ground pin are substantially parallel to each other and are substantially perpendicular to the ground bar.

7. The connector of claim 1, wherein the ground bar is connected to the first ground pin and the second ground pin without contacting the first signal pin, wherein the ground bar conductively couples the first ground pin and the second ground pin.

8. The connector of claim 1 further comprising an additional ground bar disposed within the housing, wherein the ground bar and the additional ground bar are uniformly distributed in connecting the first ground pin and the second ground pin at corresponding middle portions of the first ground pin and the second ground pin.

9. A system comprising:
a first component;
a second component; and
a connector comprising:
a housing comprising a first receptacle through which the first component is inserted;
a first signal pin disposed within the housing, the first signal pin to contact a first contact electrode on the first component responsive to the first component being inserted into the first receptacle;
a first ground pin disposed within the housing, the first ground pin to contact a first ground contact electrode on the first component responsive to the first component being inserted into the first receptacle;
a second ground pin disposed within the housing, the second ground pin to contact a second ground contact electrode on the first component responsive to the first component being inserted into the first receptacle; and
a ground bar disposed within the housing, the ground bar connected between a first connection point of the first ground pin and a second connection point of the second ground pin.

10. The system of claim 9, wherein:
the connector comprises a plurality of ground pins disposed within the housing;
the plurality of ground pins comprises the first ground pin and the second ground pin; and
the ground bar is connected to each of the plurality of ground pins at a corresponding middle portion of each of the plurality of ground pins without contacting an additional ground component.

11. The system of claim 9, wherein a corresponding first distal end of each of the first signal pin, the first ground pin, and the second ground pin is to contact the first component and a corresponding second distal end of each of the first signal pin, the first ground pin, and the second ground pin is to contact a corresponding contact electrode of the second component.

12. The system of claim 9, wherein:
the connector comprises a plurality of signal pins disposed within the housing;
the plurality of signal pins comprises the first signal pin; and
for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.

13. The system of claim 9, wherein:
the ground bar comprises a first ground notch connected to the first ground pin and a second ground notch connected to the second ground pin;
the first ground notch and the second ground notch maintain the ground bar at least a threshold distance away from the first signal pin; and
the first signal pin, the first ground pin, and the second ground pin are substantially parallel to each other and are substantially perpendicular to the ground bar.

14. The system of claim 9, wherein the first component is an edge card connector and the second component is an add-in card (AIC).

15. The system of claim 9, wherein the first component is a printed circuit board (PCB) and the second component is a cable assembly.

16. An interconnect assembly comprising:
a housing comprising a first distal end to couple to a first component and a second distal end to couple to a second component;
a first signal pin disposed within the housing, the first signal pin to contact a first contact electrode on the first component at the first distal end to contact a second contact electrode on the second component at the second distal end;
a first ground pin disposed within the housing, the first ground pin to contact a first ground contact electrode on the first component at the first distal end and to contact a second ground contact electrode on the second component at the second distal end;
a second ground pin disposed within the housing, the second ground pin to contact a third ground contact electrode on the first component at the first distal end and to contact a fourth ground contact electrode on the second component at the second distal end; and
a ground bar disposed within the housing, the ground bar connected between a first connection point of the first ground pin and a second connection point of the second ground pin.

17. The interconnect assembly of claim 16, wherein the interconnect assembly is an edge card connector and the first component is an add-in card.

18. The interconnect assembly of claim 16, wherein the interconnect assembly is a cable assembly connector and the first component is a cable assembly.

19. The interconnect assembly of claim 16, wherein:
the interconnect assembly comprises a plurality of ground pins disposed within the housing;
the plurality of ground pins comprises the first ground pin and the second ground pin; and
the ground bar is connected to each of the plurality of ground pins at a corresponding middle portion of each of the plurality of ground pins without contacting an additional ground component.

20. The interconnect assembly of claim 16, wherein:
the interconnect assembly comprises a plurality of signal pins disposed within the housing;
the plurality of signal pins comprises the first signal pin; and
for each of the plurality of signal pins, a corresponding distance between the ground bar an a corresponding signal pin is greater than a second distance between the corresponding signal pin and a corresponding ground pin of the plurality of ground pins that is most proximate the corresponding signal pin.
